(19) United States
(12) Patent Application Publication
(10) Pub. No.: US 2015/0230028 A1
(43) Pub. Date: Aug. 13, 2015

(54) MEMS MICROPHONE

(71) Applicant: SAMSUNG ELECTRO-MECHANICS CO., LTD., Gyeonggi-Do (KR)

(72) Inventors: Heung Woo PARK, Gyeonggi-Do (KR); Jong Woo HAN, Gyeonggi-Do (KR); Tae Hyun KIM, Gyeonggi-Do (KR)

(73) Assignee: SAMSUNG ELECTRO-MECHANICS CO., LTD., Gyeonggi-Do (KR)

(21) Appl. No.: 14/303,799

(22) Filed: Jun. 13, 2014

(30) Foreign Application Priority Data
Feb. 7, 2014 (KR) 10-2014-0014117

(51) Int. Cl. H04R 23/00

(52) U.S. Cl. CPC H04R 23/00; H04R 2201/003

(57) ABSTRACT

Embodiments of the invention provide a micro electro mechanical systems (MEMS) microphone, which includes a microphone chip, a premold lead frame comprising a lead frame to which the microphone chip is electrically connected, and a cover coupled to the premold lead frame to cover the microphone chip and electrically connected to the premold lead frame.

### CROSS REFERENCE TO RELATED APPLICATION

This application claims the benefit of and priority under 35 U.S.C. §119 to Korean Patent Application No. KR 10-2014-0014117, entitled “MEMS MICROPHONE,” filed on Feb. 7, 2014, which is hereby incorporated by reference in its entirety into this application.

### BACKGROUND

1. Field of the Invention

The present invention relates to a micro electro mechanical systems (MEMS) microphone.

2. Description of the Related Art

In general, a MEMS device that converts a physical phenomenon, such as a pressure, acceleration, sound or light into an electrical signal, includes a MEMS chip and an application specific integrated circuit (ASIC) chip.

Also, a MEMS device having a structure in which a MEMS chip and an ASIC chip are attached to be vertically stacked to various substrates (a printed circuit board (PCB), a lead frame, or a leadless chip carrier (LCC), as non-limiting examples) or are axially arranged is currently manufactured.

Also, a MEMS device as described, for example, in U.S. Pat. No. 7,550,828, is formed of a stack substrate in which a cavity is formed and a MEMS chip and an ASIC chip are mounted on the substrate in which the cavity is formed, and various wirings that electrically connect the MEMS chip and the ASIC chip are formed. Thus, the manufacturing process thereof is complicated, and this increases the costs.

### SUMMARY

Accordingly, embodiments of the invention have been made in an effort to provide a micro electro mechanical systems (MEMS) microphone having a simplified structure and radio frequency interference (RFI) shielding effects at the same time, as a base substrate of the MEMS microphone is formed of a premold lead frame and is formed to be electrically connected to a cover that is coupled to the base substrate.

Furthermore, embodiments of the present invention have been made in an effort to provide a MEMS microphone having an improved coupling force as a premold lead frame and a cover are more firmly coupled to each other physically and electrically.

According to an embodiment of the invention, there is provided a MEMS microphone, including a microphone chip, a premold lead frame including a lead frame to which the microphone chip is electrically connected, and a cover coupled to the premold lead frame to cover the microphone chip and electrically connected to the premold lead frame.

According to an embodiment, the premold lead frame further includes a metal portion electrically connected to the cover, and a conductive connection portion that electrically connects the lead frame and the metal portion.

According to an embodiment, a plurality of the lead frames are mounted on the premold lead frame, and at least one of the plurality of lead frames is electrically connected to the metal portion via the conductive connection portion.

According to an embodiment, the metal portion is formed to surround a boundary portion of the premold lead frame.

According to an embodiment, a coupling portion protruding to face the premold lead frame is formed in the cover, and a conductive portion to be electrically connected to the metal portion of the premold lead frame is formed in the coupling portion.

According to an embodiment, the metal portion of the premold lead frame is formed to protrude, and a groove corresponding to the metal portion is formed in the coupling portion of the cover, and the conductive portion is formed in the groove, and the metal portion of the premold lead frame is inserted into the groove of the cover and electrically connected to the conductive portion of the cover.

According to an embodiment, the conductive portion of the cover is formed to protrude, and a coupling portion that faces the cover is formed in the premold lead frame, and a groove corresponding to the conductive portion of the cover is formed in the coupling portion, and a metal portion is formed in the groove, and the conductive portion of the cover is inserted into the groove of the premold lead frame and is electrically connected to the metal portion.

According to an embodiment, the premold lead frame has a cavity that corresponds to the coupling portion, to which the microphone chip is coupled, and is opened to a side.

According to an embodiment, the microphone chip and the lead frame are electrically connected to each other via a conductive wire.

According to an embodiment, the premold lead frame is formed by molding an epoxy.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is an exploded perspective view schematically illustrating a micro electro mechanical systems (MEMS) microphone according to an embodiment of the invention.

FIG. 2 is a partial plan view schematically illustrating the MEMS microphone illustrated in FIG. 1 according to an embodiment of the invention.

FIG. 3 is a cross-sectional view schematically illustrating the MEMS microphone illustrated in FIG. 1 in a coupled state cut along a line A-A′ according to an embodiment of the invention.

FIG. 4 is a partial exploded cross-sectional view schematically illustrating a MEMS microphone according to another embodiment of the present invention.

FIG. 5 is an exploded partial cross-sectional view schematically illustrating a MEMS microphone according to another embodiment of the present invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

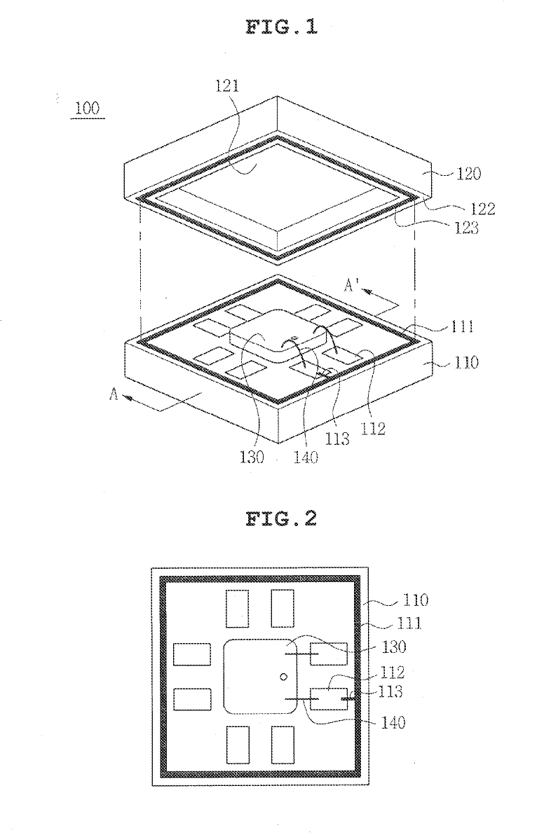

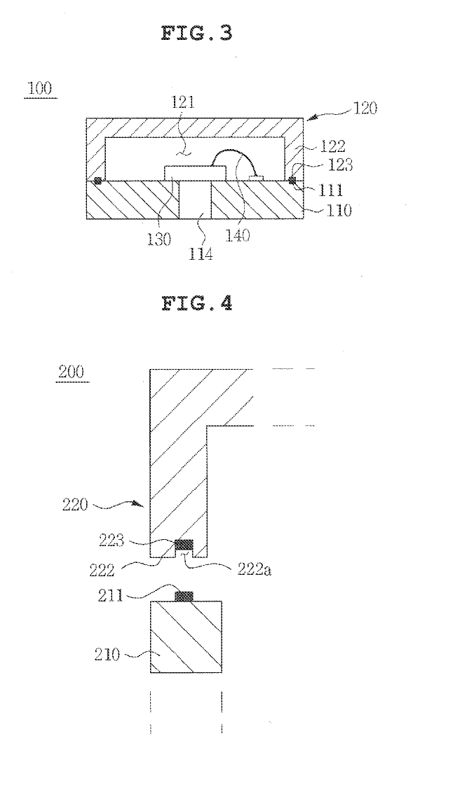

FIG. 1 is an exploded perspective view schematically illustrating a micro electro mechanical systems (MEMS) microphone according to an embodiment of the invention, FIG. 2 is a partial plan view schematically illustrating the MEMS microphone illustrated in FIG. 1 according to an embodiment of the invention, and FIG. 3 is a cross-sectional view schematically illustrating the MEMS microphone illustrated in FIG. 1 in a coupled state cut along a line A-A′ according to an embodiment of the invention.

As illustrated in the drawings, the MEMS microphone, according to at least one embodiment, 100 includes a premold lead frame 110, a cover 120, and a microphone chip 130.

In detail, the premold lead frame 110 includes a metal portion 111, a lead frame 112, and a conductive connection portion 113.

Also, the premold lead frame 110, according to at least one embodiment, is formed by molding an epoxy.

First, the metal portion 111 is electrically connected to the cover 120 and is formed to correspond to a position to which the cover 120 is coupled. Also, the metal portion 111 is formed in various forms. In FIGS. 1 and 2, as an example, the metal portion 111 is formed to surround a boundary portion of the premold lead frame 110.

Also, the lead frame 112 is a conductive plate which is electrically connected to the microphone chip 130 via a wire, and a plurality of lead frames 112 is formed.

According to an embodiment, the conductive connection portion 113 is formed to electrically connect at least one of the plurality of lead frames 112 and the metal portion 111. A first end of the conductive connection portion 113 is connected to the metal portion 111, and a second end of the conductive connection portion 113 is connected to the lead frame 112.

According to an embodiment, a cavity 114 is formed in the premold lead frame 110 to correspond to a coupling portion of the microphone chip 130, such that a side of the premold lead frame 110 is opened.

Next, according to an embodiment, the cover 120 is coupled to the premold lead frame 110 to cover the microphone chip 130. The cover 120 includes a space portion 121 and a coupling portion 122 protruding to face the premold lead frame 110, and a conductive portion 123 to be electrically connected to the metal portion 111 of the premold lead frame 110 is formed in the coupling portion 122. Also, the conductive portion 123 is formed to correspond to the position and the shape of the metal portion 111 of the premold lead frame 110.

According to an embodiment, the microphone chip 130 is mounted on the premold lead frame 110 and is electrically connected to the lead frame 112 via a wire 140.

According to an embodiment, the MEMS microphone 100, according to an embodiment of the invention, further includes an application specific integrated circuit (ASIC) chip (not shown).

As the MEMS microphone 100, according to an embodiment of the invention, is formed as described above, productivity of the MEMS microphone 100 is improved and the manufacturing costs thereof are reduced due to the premold lead frame 110, and also, a freedom degree of design is increased. Moreover, as the cover 120 is electrically connected via the premold lead frame 110, radio frequency interference (RFI) shielding effects may be obtained, and also, noise reduction effects may be obtained as parasitic capacitance caused in wirings between printed circuit boards (PCBs) is reduced. Furthermore, the MEMS microphone 100 is less affected by an external stress, and heat may be easily dissipated therefrom as the MEMS microphone 100 is formed of a single layer substrate, and a high back volume may be improved greatly due to the cavity, thereby improving acoustic characteristics.

FIG. 4 is a partial exploded cross-sectional view schematically illustrating a MEMS microphone 200 according to another embodiment of the present invention. As illustrated in FIG. 4, a premold lead frame 210 of the MEMS microphone 200 includes a metal portion 211 that protrudes, and a groove 222a corresponding to the metal portion 211 is formed in a coupling portion 222 of the cover 220, and a conductive portion 223 to be electrically connected to the metal portion 211 is formed in the groove 222a.

As the MEMS microphone 200 is formed as described above, when the premold lead frame 210 and the cover 220 are coupled, the metal portion 211 of the premold lead frame 210 is inserted into and coupled to the groove 222a formed in the coupling portion 222 of the cover 220, and at the same time, the metal portion 211 and the conductive portion 223 electrically contact each other so that a coupling force of the MEMS microphone 200, according to another embodiment of the invention, is improved as the premold lead frame 210 and the cover 220 are physically and electrically more firmly coupled.

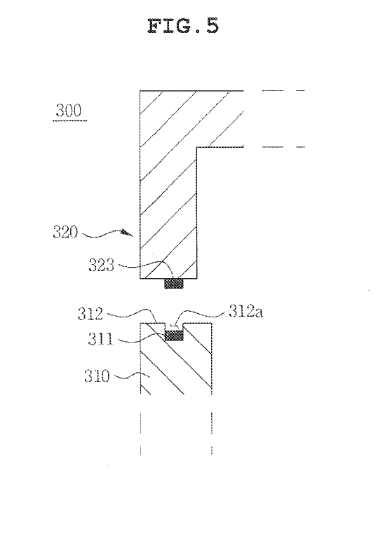

FIG. 5 is an exploded partial cross-sectional view schematically illustrating a MEMS microphone 300 according to another embodiment of the present invention. As illustrated in FIG. 5, a conductive portion 323 is formed to protrude from a cover 320 of the MEMS microphone 300. A coupling portion 312 is formed in the premold lead frame 310 to face the cover 320, and a groove 312a corresponding to the conductive portion 323 of the cover 320 is formed in the coupling portion 312. A metal portion 311 to be electrically connected to the conductive portion 323 of the cover 320 is formed in the groove 312a.

As the MEMS microphone 300 is formed as described above, when the premold lead frame 310 and the cover 320 are coupled, the conductive portion 323 of the cover 320 is inserted into and coupled to the groove 312a formed in the coupling portion 312 of the premold lead frame 310, and at the same time, the metal portion 311 and the conductive portion 323 electrically contact each other so that a coupling force of the MEMS microphone 300 according to another embodiment of the present invention is improved as the premold lead frame 310 and the cover 320 are physically and electrically more firmly coupled.

As set forth above, according to various embodiments of the invention, as a base substrate of the MEMS microphone is formed of a premold lead frame and is formed to be electrically connected to a cover that is coupled to the base substrate, the MEMS microphone has a simple structure and RFI shielding effects are obtained. In addition, a MEMS microphone having an improved coupling force is provided as the premold lead frame and the cover are physically and electrically more firmly coupled.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A micro electro mechanical systems (MEMS) microphone, comprising:
a microphone chip;
a premold lead frame comprising a lead frame to which the microphone chip is electrically connected; and
a cover coupled to the premold lead frame to cover the microphone chip and electrically connected to the premold lead frame.

2. The MEMS microphone according to claim 1, wherein the premold lead frame further comprises:
a metal portion electrically connected to the cover; and
a conductive connection portion configured to electrically connect the lead frame and the metal portion.

3. The MEMS microphone according to claim 2, wherein a plurality of the lead frames are mounted on the premold lead frame, and at least one of the plurality of lead frames is electrically connected to the metal portion via the conductive connection portion.

4. The MEMS microphone according to claim 2, wherein the metal portion is formed to surround a boundary portion of the premold lead frame.

5. The MEMS microphone according to claim 2, wherein a coupling portion protruding to face the premold lead frame is formed in the cover, and a conductive portion to be electrically connected to the metal portion of the premold lead frame is formed in the coupling portion.

6. The MEMS microphone according to claim 5, wherein the metal portion of the premold lead frame is formed to protrude,
wherein a groove corresponding to the metal portion is formed in the coupling portion of the cover, and the conductive portion is formed in the groove, and
wherein the metal portion of the premold lead frame is inserted into the groove of the cover and is electrically connected to the conductive portion of the cover.

7. The MEMS microphone according to claim 5, wherein the conductive portion of the cover is formed to protrude,
wherein a coupling portion that faces the cover is formed in the premold lead frame, and a groove corresponding to the conductive portion of the cover is formed in the coupling portion, and a metal portion is formed in the groove, and
wherein the conductive portion of the cover is inserted into the groove of the premold lead frame and is electrically connected to the metal portion.

8. The MEMS microphone according to claim 1, wherein the premold lead frame comprises a cavity that corresponds to the coupling portion to which the microphone chip is coupled and is opened to a side.

9. The MEMS microphone according to claim 1, wherein the microphone chip and the lead frame are electrically connected to each other via a conductive wire.

10. The MEMS microphone according to claim 1, wherein the premold lead frame is formed by molding an epoxy.
